(19) United States
(12) Patent Application Publication
(10) Pub. No.: US 2012/0227271 A1
(43) Pub. Date: Sep. 13, 2012

(54) Tool Device

(75) Inventors: Sebastian Krieger, Ehingen (DE); Thilo Koeder, Gerlingen (DE); Joachim Platzer, Remseck-Hochberg (DE); Ulli Hoffmann, Niefern-Oeschelbronn (DE)

(73) Assignee: Robert Bosch GmbH, Stuttgart (DE)

(21) Appl. No.: 13/393,676

(22) PCT Filed: Jul. 15, 2010
(86) PCT No.: PCT/EP2010/060185

§ 371 Date: Jun. 4, 2012

(30) Foreign Application Priority Data
Sep. 2, 2009 (DE) 10 2009 029 104.0

(51) Int. Cl. B23D 49/16

(52) U.S. Cl. 30/374

(57) ABSTRACT

A tool device, in particular a jigsaw device, includes at least one guide unit for at least partially guiding at least one machine body and/or a workpiece processing motion. The tool device further includes at least one alignment detection unit for detecting an alignment of the guide unit relative to a motor housing and/or relative to a tool receiving unit.

### PRIOR ART

The invention is based on a tool device according to the preamble of claim 1.

A jigsaw having a sole plate which is provided for guiding the entire jigsaw is already known.

### DISCLOSURE OF THE INVENTION

The invention is based on a tool device, in particular a saw device, having at least one guide unit which is provided for at least partly guiding at least one machine body and/or a workpiece machining motion.

It is proposed that the tool device have at least one orientation detecting unit which is provided for detecting an orientation of the guide unit relative to a motor housing and/or relative to a tool holding unit. The expression “provided” is to be understood as being specifically designed and/or specifically equipped. The statement to the effect that the guide unit is provided for “at least partly” guiding at least one machine body and/or a workpiece machining motion is intended in particular to refer to the fact that the guide unit is provided for guiding at least one machine body and/or at least one workpiece machining motion in at least one direction. In this case, the guide unit is preferably provided for sliding on a surface of a workpiece and for guiding the machine body by sliding on the surface of the workpiece. The expression “machine body” is intended in particular to refer to a part of the tool device which has at least one motor for driving a tool and which preferably has at least one handle which is provided for being grasped by an operator during an operating procedure. The expression “detecting” an orientation of the guide unit relative to a motor housing and/or relative to a tool holding unit is intended in particular to refer to sensing at least one orientation parameter and/or calculating at least one orientation parameter from at least one sensed parameter, wherein the orientation parameter describes at least partly or preferably completely a situation and/or a position of the guide unit relative to the motor housing and/or relative to the tool holding unit. Usability tailored to the requirements can be achieved with a configuration according to the invention. In particular, precise machining of a workpiece can be achieved.

Furthermore, it is proposed that the orientation detecting unit be provided for detecting at least one rotary parameter of a rotary position of the guide unit relative to the motor housing and/or relative to the tool holding unit. The expression “rotary parameter” is intended in particular to refer to a parameter from which an angle of rotation and in particular an angle of rotation by which the guide unit is rotated relative to the machine body starting from a reference position can be extracted and preferably calculated by an evaluating unit. Ease of use can thus be achieved. In particular, a flexible, simple, precise and functionally versatile orientation of the guide unit relative to the machine housing can be achieved. In particular, miters can be sawn in an especially simple and precise manner.

The orientation detecting unit is preferably provided for continuously detecting the orientation. The statement to the effect that “the orientation detecting unit is provided for continuously detecting the orientation” is intended in particular to refer to the fact that the orientation detecting unit is provided for detecting changes in the orientation of the guide unit relative to the motor housing and/or relative to the tool holding unit which are characterized by changes in an orientation parameter in such a way that the changes in the orientation parameter are continuously detected, the continuous detection differing from a gradual detection of the changes in the orientation parameter, in which the orientation parameter can only assume a finite number of certain values. As a result, accurate adjustability and in particular an accurate orientation of the guide unit can be achieved.

The orientation detecting unit advantageously has at least one electric contact which can be released without the use of a tool and/or at least one switch and/or at least one sliding contact. The expression “electric contact which can be released without the use of a tool” is intended in particular to refer to an electric contact which can be interrupted in a non-destructive manner and without the use of a tool. A cost-effective type of construction can thus be achieved. The electric contact or the sliding contact preferably forms a sensor element, as a result of which a simple type of construction can be achieved.

In addition, it is proposed that the orientation detecting unit have at least one non-contact sensor unit. The expression “non-contact sensor unit” is intended in particular to refer to a sensor unit which carries out at least one sensing operation in a non-contact manner. Reliable functioning can thus be achieved. In particular, contaminants will have little influence on a sensing operation.

The non-contact sensor unit advantageously has at least one camera. The amount of components can thus be reduced. In particular, a camera whose main task differs from the orientation detection can be used for the orientation detection.

Furthermore, it is proposed that the guide unit have at least one position detecting mark. The expression “position detecting mark” is intended in particular to refer to a mark which, during at least one operating procedure, is used by the orientation detecting unit to determine a position of the guide unit relative to the motor housing and/or relative to the tool holding unit. As a result, a simple type of construction can be achieved.

The orientation detecting unit advantageously has at least one distance sensor, as a result of which reliable functioning can be achieved.

The tool device preferably has at least one indicating unit which is provided for indicating an orientation parameter. Ease of use can thereby be achieved. In particular, an operator can be informed about an orientation of the guide unit.

Furthermore, it is proposed that the tool device have at least one orientation unit which is provided for orienting the tool holding unit and/or a tool automatically relative to a machining mark. The statement to the effect that the orientation unit orients the tool holding unit and/or the tool is intended in particular to refer to the fact that the orientation unit moves the tool holding unit or the tool relative to the motor housing and/or relative to the machine body. The expression “machining mark” is intended in particular to refer to a mark on a workpiece along which the tool is to be moved in order to carry out a machining operation. In this way, ease of use can be achieved.

Furthermore, it is proposed that the tool device have at least one deactivating unit which is provided for deactivating the orientation unit according to an orientation of the guide unit relative to the tool holding unit and/or relative to the motor housing. Reliable functioning can thus be achieved. In particular, a situation in which the orientation unit is active when producing a miter by means of the tool device can be avoided, as a result of which a malfunction is prevented.

Furthermore, a power tool having a tool device is proposed, as a result of which usability tailored to the requirements can be achieved.

Furthermore, a method, in particular using a power tool, is proposed, in which an orientation of a guide unit relative to a motor housing and/or relative to a tool holding unit is detected, said guide unit being provided for at least partly guiding at least one machine body and/or a workpiece machining motion. Usability tailored to the requirements can thus be achieved.

Further advantages follow from the description of the drawing below. Exemplary embodiments of the invention are shown in the drawing. The drawing, the description and the claims contain numerous features in combination. The person skilled in the art will also expediently consider the features individually and combine them to form appropriate further combinations.

In the drawing:

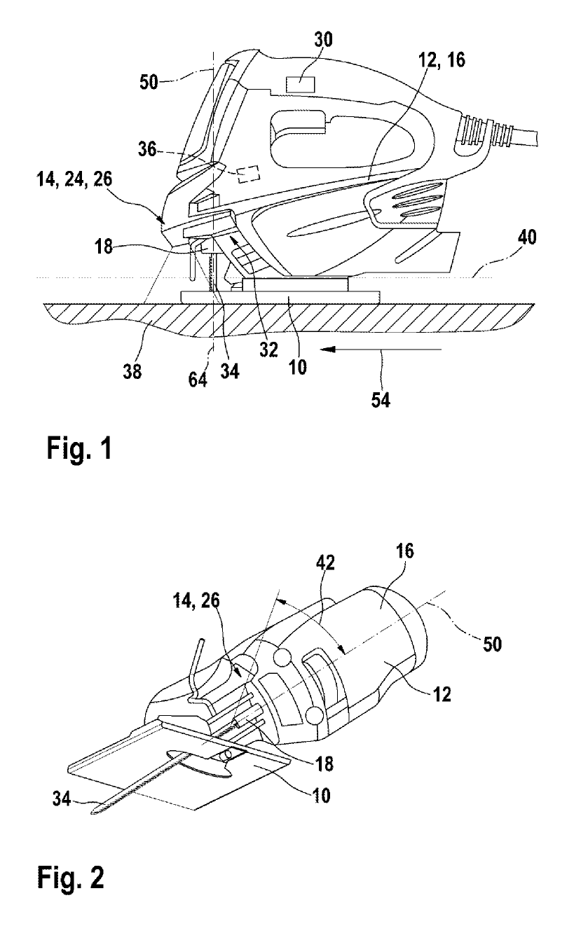

FIG. 1 shows a side view of a power tool with a tool device,

FIG. 2 shows a view of the power tool, wherein a machine body of the power tool is inclined relative to a sliding shoe of the power tool,

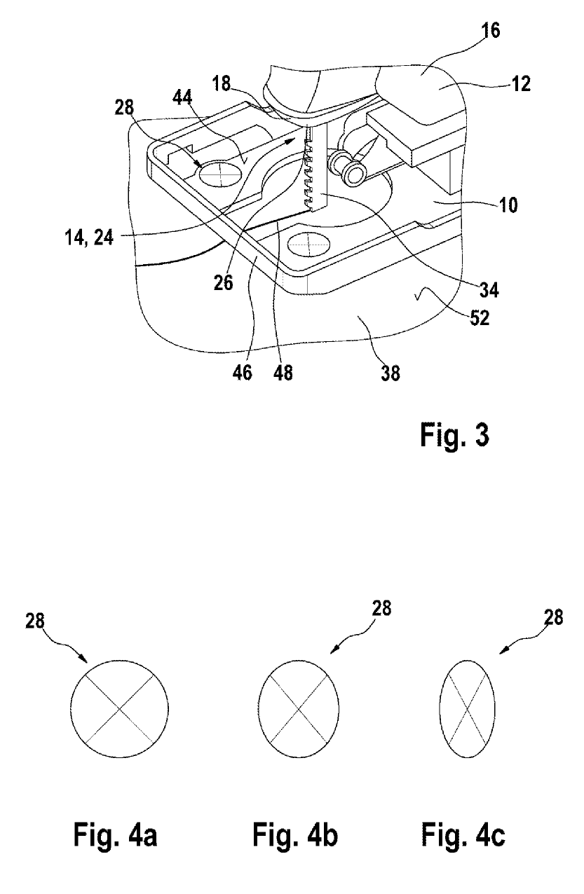

FIG. 3 shows a view of the power tool, wherein the sliding shoe, which forms a guide unit, is arranged in a standard position,

FIG. 4a shows a camera image of a position detecting mark of the sliding shoe, wherein the sliding shoe is arranged in the standard position,

FIG. 4b shows a camera image of the position detecting mark of the sliding shoe, wherein the sliding shoe is deflected slightly from the standard position,

FIG. 4c shows a camera image of the position detecting mark of the sliding shoe, wherein the sliding shoe is deflected considerably from the standard position,

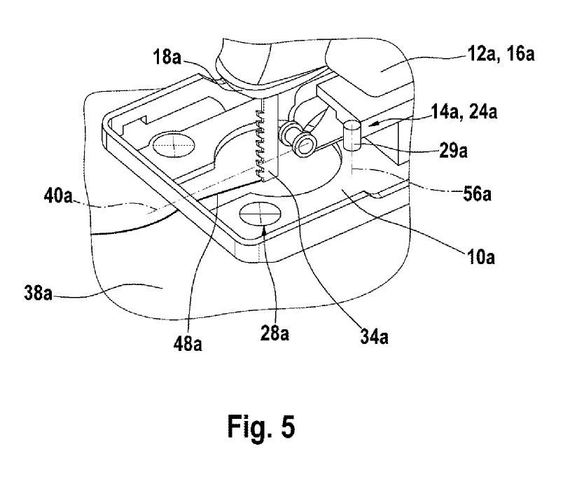

FIG. 5 shows an alternative exemplary embodiment of an orientation detecting unit, wherein the orientation detecting unit has a distance sensor,

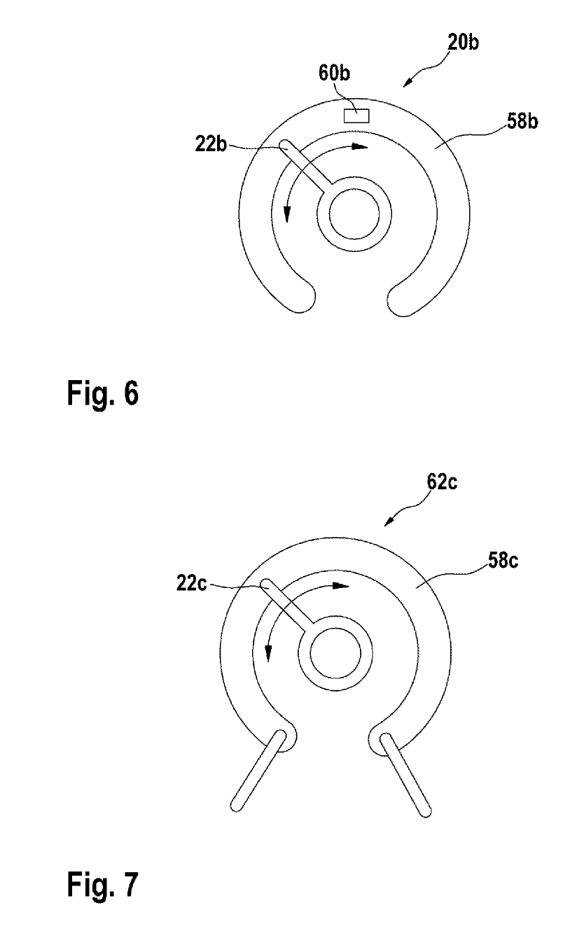

FIG. 6 shows an alternative exemplary embodiment of an orientation detecting unit, wherein the orientation detecting unit has an electric contact,

FIG. 7 shows an alternative exemplary embodiment of an orientation detecting unit, wherein the orientation detecting unit has a potentiometer, and

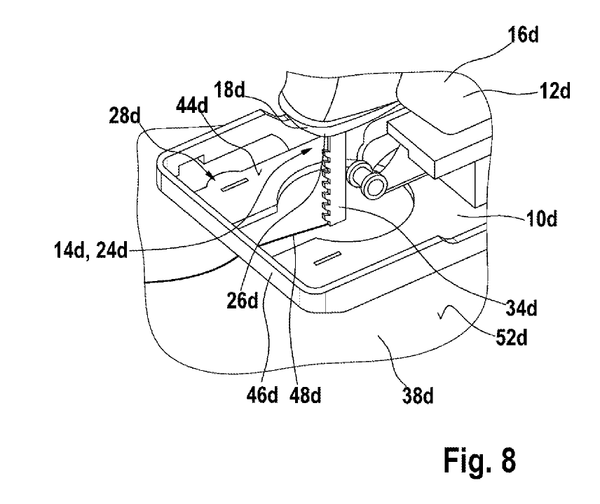

FIG. 8 shows an alternative exemplary embodiment of a position detecting mark.

### DESCRIPTION OF THE EXEMPLARY EMBODIMENTS

FIG. 1 shows a jigsaw having a tool device according to the invention, which is designed as a jigsaw device and has a guide unit 10. The guide unit 10 is provided for guiding the jigsaw and in particular a machine body 12 of the tool device, said machine body 12 having a motor housing 16, during a workpiece machining motion, during which a workpiece 38 is sawn, by the guide unit 10 sliding on the workpiece 38. The guide unit 10 is arranged relative to the machine body 12 in a standard position, which is not intended for providing a workpiece with a miter during operation of the jigsaw. In the standard position, a main extension direction 64 of a tool 34, designed as a saw blade, of the tool device is oriented perpendicularly to a surface 44 of the guide unit 10. The guide unit 10 is mounted so as to be rotatable relative to the machine body 12 about an axis 40, such that a user can rotate the guide unit 10, designed as a sliding shoe, relative to the machine body 12 by an angle 42 from the standard position into an inclined position (FIG. 2). A tool holding unit 18 of the tool device, which tool holding unit 18 is connected to the machine body and in which the tool 34 of the tool device is mounted, is likewise rotated by the angle 42 about the axis 40 by such a rotation. By operation of the jigsaw in a state in which the guide unit 10 is rotated about the machine body 12, the workpiece 38 can be provided with a miter by means of the jigsaw.

Furthermore, the tool device has an orientation detecting unit 14 which continuously detects the angle during an operating procedure. To this end, the orientation detecting unit 14 has a non-contact sensor unit 24 with a camera 26. During the operating procedure, the camera 26 photographs a position detecting mark 28 (FIG. 3) of the guide unit 10, which is arranged on the surface 44 of the guide unit 10. The position detecting mark 28 has two lines which intersect one another at an angle of ninety degrees. Depending on whether the guide unit is arranged in the standard position or is rotated from said standard position by the angle 42, the camera 26 perceives the position detecting mark 28 in different ways (FIGS. 4a to 4c), wherein an angle at which the two lines intersect will deviate all the more so from ninety degrees, the greater the angle 42. An image which the camera 26 records during the operating procedure is transmitted to an evaluating unit (not shown) which calculates the angle 42 from the angle at which the two lines intersect. Alternatively or additionally, the evaluating unit can also obtain the angle 42 by the evaluating unit determining in an image recorded by the camera 26 a distance of a point of a first line of the set of lines from a point of a second line of the set of lines and comparing it with values which are stored in a memory unit of the evaluating unit. This is especially advantageous for the case where only individual lines of an image of the camera 26 are evaluated. Here, the points are intersections of a straight line which runs in the image of the camera and which, in the standard position of the guide unit 10, is parallel to a front edge 46 of the guide unit 10, is at a certain distance from the front edge 46 during the operating procedure and is fixed relative to the machine body 12 when the guide unit 10 is rotated relative to the machine body 12. The camera 26 is part of the machine body 12.

In addition, the tool device has an orientation unit 32 which in an operating mode rotates the tool holding unit 18 and the tool 34 automatically relative to the machine body 12 and relative to a machining mark 48 about an axis 50. The axis 50 runs perpendicularly to the axis 40 and, if a surface 52 of the workpiece 38 on which the guide unit 10 slides during the operating procedure is flat, perpendicularly to the surface 52. The camera 26 and the evaluating unit are part of the orientation unit. The camera 26 records an image of the machining mark 48 and transmits the image to the evaluating unit, which causes the tool holding unit 18 to rotate by means of a motor (not shown) of the tool device, which rotation, while a force is exerted on the machine body 12 in a longitudinal extension direction 54 by the user, causes the tool 34 to saw along the machining mark 48. The evaluating unit transmits the calculated angle 42 to a deactivating unit 36 of the tool device, which, if the angle 42 is not equal to zero degrees, switches off the orientation unit 32.

During the operating procedure, the angle 42 is indicated by an indicating unit 30, designed as a display, of the tool device. The indicating unit 30 can in principle also be formed by light emitting diodes and marks for various angles, the light emitting diodes marking the marks.

In principle, it is conceivable for the guide unit 10 not to be rotatable relative to the machine body 12, but rather for it to be freely displaceable on a housing shell of the machine body 12. In principle, it is conceivable for an orientation of the guide unit 10 relative to the machine body 12 to be detected by means of a non-contact sensor which has an inductive or capacitive or optical operating principle and can be, for example, a Hall sensor or a magnetoresistive sensor. In this case, the Hall sensor can take into account, for example, magnets moving past the Hall sensor. Furthermore, it is in principle conceivable for the orientation detecting unit 14 to have a fork light barrier and/or a retro-reflective light barrier on the machine body which detects increments and/or marks and/or a coded scale which can be provided on the guide unit 10.

The camera 26 can have a CCD sensor and/or a CMOS sensor.

Alternative exemplary embodiments are shown in FIGS. 5 to 8. Components, features and functions which remain substantially the same are basically provided with the same reference numerals. For differentiating the exemplary embodiments, however, the letters “a”, “b”, etc., are added to the reference numerals of the exemplary embodiments in FIGS. 5 to 8. The description below is restricted substantially to the differences from the exemplary embodiment in FIGS. 1 to 4, and reference can be made to the description of the exemplary embodiment in FIGS. 1 to 4 with regard to components, features and functions that remain the same.

FIG. 5 shows part of a jigsaw with an alternative exemplary embodiment of an orientation detecting unit 14a which has a distance sensor 29a which is part of a machine body 12a of the jigsaw and is arranged at a distance from an axis about which a guide unit 10a of the jigsaw can be rotated around the machine body 12a. During an operating procedure, the distance sensor 29a, which operates in a non-contact manner, measures a distance between a guide unit 10a of the jigsaw and the distance sensor 29a along a straight line 56a, which is fixed relative to the machine body 12a. An evaluating unit (not shown) of the jigsaw determines from the distance an angle about which the guide unit 10a is rotated relative to the machine body 12a.

FIG. 6 shows a schematic illustration of an alternative exemplary embodiment of part of an orientation detecting unit 14b which has an electric contact 20b which can be released without the use of a tool. The contact 20b has a sliding contact 22b which is fastened to the guide unit 10. A metallic contact point 60b is fastened to a bow 58b which is part of the machine body 12. A voltage is applied to the contact point 60b and the sliding contact 22b. If the guide unit is arranged in a standard position, current flows through the contact 20b. If the guide unit 10 is rotated out of the standard position, a current flow through the contact 20b is interrupted, as a result of which it can be detected whether the guide unit 10 is arranged in the standard position. In principle, it is conceivable for the contact 20b to be replaced by a microswitch.

FIG. 7 shows a schematic illustration of an alternative exemplary embodiment of part of an orientation detecting unit 14c which has a potentiometer 62c. The potentiometer 62c has a metallic bow 58c and a sliding contact 22c which is fastened to the guide unit 10. The bow 58c is part of the machine body 12. A constant voltage is applied to the potentiometer 62c, such that a current which flows through the potentiometer 62c depends on the angle 42, as a result of which the angle 42 can be determined.

FIG. 8 shows a guide unit 10d with alternative exemplary embodiments of position detecting marks 28d. The two position detecting marks 28d are each designed as lines and are arranged, in a plan view of the guide unit 10d, on different sides next to a tool 34d. In principle, the guide unit 10d can also have only one of the position detecting marks 28d.

1. A tool device, in particular a saw device, comprising:
at least one guide unit which is provided for at least partly guiding at least one machine body and/or a workpiece machining motion; and
at least one orientation detecting unit which is provided for detecting an orientation of the guide unit relative to a motor housing and/or relative to a tool holding unit.

2. The tool device as claimed in claim 1, wherein the orientation detecting unit is provided for detecting a rotary parameter of a rotary position of the guide unit relative to the motor housing and/or relative to the tool holding unit.

3. The tool device as claimed in claim 1, wherein the orientation detecting unit is provided for continuously detecting the orientation.

4. The tool device as claimed in claim 1, wherein the orientation detecting unit has at least one electric contact which can be released without the use of a tool and/or at least one switch and/or at least one sliding contact.

5. The tool device as claimed in claim 1, wherein the orientation detecting unit has at least one non-contact sensor unit.

6. The tool device as claimed in claim 5, wherein the non-contact sensor unit has at least one camera.

7. The tool device as claimed in claim 1, wherein the guide unit has at least one position detecting mark.

8. The tool device as claimed in claim 1, wherein the orientation detecting unit has at least one distance sensor.

9. The tool device as claimed in claim 1, further comprising:
at least one indicating unit which is provided for indicating an orientation parameter.

10. The tool device as claimed in claim 1, further comprising:
at least one orientation unit which is provided for orienting the tool holding unit and/or a tool automatically relative to a machining mark.

11. The tool device as claimed in claim 10, further comprising:
at least one deactivating unit which is provided for deactivating the orientation unit according to an orientation of the guide unit relative to the tool holding unit and/or relative to the motor housing.

12. A power tool comprising:
a tool device including (i) at least one guide unit which is provided for at least partly guiding at least one machine body and/or a workpiece machining motion, and (ii) at least one orientation detecting unit which is provided for detecting an orientation of the guide unit relative to a motor housing and/or relative to a tool holding unit.

13. A method of using a power tool, comprising:
detecting an orientation of a guide unit relative to a motor housing an/or relative to a tool holding unit; and
at least partly guiding at least one machine body and/or a workpiece machining motion with said guide unit.
